(19) United States
(12) Patent Application Publication
(10) Pub. No.: US 2003/0195844 A1
(43) Pub. Date: Oct. 16, 2003

(54) Electronic bill and non-bill information presentation

(76) Inventor: Lawrence Daniel Hogan, Northville, MI (US)

Correspondence Address: LALOS & KEEGAN, Fifth Floor, 1146 Nineteenth Street, NW, Washington, DC, 20036, US

(21) Appl. No.: 09/867,589

(22) Filed: May 31, 2001

(51) Int. Cl. G06F 17/60

(52) U.S. Cl. 705/40; 705/39

(57) ABSTRACT

The present invention discloses a technique for presenting a bill and associated non-bill information via a network. The technique includes transmitting a bill to a payer. The bill includes a first charge and a second charge. The bill also includes a first link to non-bill information and a second link to non-bill information. Non-bill information is information upon which a charge is based. A request for non-bill information is received from the payer. The non-bill information is transmitted to the payer in response to receipt of the request.

### FIELD OF THE INVENTION

The present invention relates to electronic bill presentment and more particularly to combining electronic presentation of billing information with electronic presentation of non-bill information.

### BACKGROUND OF THE INVENTION

Billers have traditionally presented bills to their customers in paper form. With the advent of affordable computers and widespread network access, bill presentment has migrated from paper presentment to electronic presentment. Electronic bill presentment is achieved by various methods. For example, some bills are presented via e-mail, some are presented via the World Wide Web, and some are presented via private network links between billers and customers. No matter the electronic method by which a bill is presented, it will be understood that information indicating an amount owed is transmitted to a customer's computing device in electronic bill presentment.

Electronic bills are not only presented by billers themselves, but also by bill presentment service providers. Bill presentment service providers obtain billing information from billers and in turn electronically present bills to customers of the billers. This billing information can be obtained directly from a biller's computer system by a bill presentment service provider, or it can be obtained from a paper copy of a bill that has previously been generated by a biller's computer system. Electronic bills that are presented by billers are often said to be presented via a biller-direct system. Electronic bills that are presented by bill presentment service providers are often said to be presented via a bill aggregation system. There are also hybrid electronic bill presentment systems in which a portion of a bill is electronically presented by a biller and another portion of the same bill is electronically presented by a bill presentment service provider. Typically, in a hybrid system, summary bill information, such as an amount owed, is presented by a bill presentment service provider, while bill detail, such as line item charges, is presented by a biller. Such systems allow the biller to maintain control of the bill presentation experience.

Often coupled with electronic bill presentment is electronic bill payment. Customers who receive bills electronically are typically enabled to pay the bills electronically. Billers and bill presentment service providers offer various payment options. These options can include payment via credit card, via electronic check, via stored value account, or via an electronic payment service, such as offered by CheckFree, the assignee of the present invention. One electronic payment service offered by CheckFree, E-BILL™, combines electronic bill presentment on behalf of billers with electronic bill payment on behalf of customers.

Many types of bills are electronically presented. These include utility bills, credit card bills, tax bills, retail merchant bills, and insurance premiums. As with paper bills, electronic bills can either be for future services, such as a periodic flat rate utility service or insurance premium, or electronic bills can be for goods or services purchased in the past, such as a metered utility or a monthly credit card statement.

As will be understood by one skilled in the art, a bill, whether paper or electronic, typically includes bill detail. Bill detail is a description of the goods or services being billed, often including an itemization of charges included in the bill. This description can include the quantity of goods purchased, i.e., kilowatt-hours of electricity consumed, the rate at which a good or service is sold, i.e., hourly fee or price per unit, and charges levied by governmental agencies, i.e., sales tax.

Many bills are associated with an underlying contract or governmental regulation, known as a tariff. For example, an insurance premium is a payment for a service in which an insurer contractually guarantees to pay an expense on behalf of a customer of the insurer. The services provided by the insurer are described by an insurance contract. Also for example, mortgage payments are contractually mandated payments on a loan that is secured by real property. And, also for example, a residential telephone bill or a cable television bill are each bills for a service that is often regulated by a government tariff.

Bills that are associated with an underlying contract or tariff often make reference to the underlying contract or tariff in bill detail. For example, FIG. 1 shows a prior art electronically presented insurance premium 101 for automobile insurance shown presented on a computer display 170. The example bill includes an itemization of insurance coverage provided. According to this example, the total amount 102 of the premium is $176 dollars, with $37.94 of that total charged for bodily injury-liability insurance 103, with $8.33 for medical payments insurance 104, with $43.52 for comprehensive insurance 105, with $62.90 for collision insurance 106, and with $23.31 for uninsured motor vehicle insurance 107. Each of these itemized charges includes a brief description and a code. The bodily injury-liability charge is associated with code A 108. The medical payments charge is associated with code C 109. The comprehensive charge is associated with code D50 110. The collision charge is associated with code G250 111. The uninsured motor vehicle charge is associated with code U 112. Each of these codes is a reference to the underlying contract. More particularly, each of these codes is a reference to a portion of the underlying contract. As will be understood by one skilled in the art, the contract contains a complete description of each of these codes. To gain a complete understanding of the itemized charges, a customer must make reference to the underlying contract.

The parties to an underlying contract, the biller and the customer, typically each are in possession of a copy of the contract. An underlying contract is often a lengthy document. Printing and postage costs associated with providing a customer a paper copy of the contract increases as the length of the contract increases. As such, typically, only one copy of the underlying contract is provided to the customer at the inception of a contractual agreement. Occasionally during the life of a contract, such as an insurance contract, the agreement changes. In such cases, relevant changed portions of the contract are supplied to the customer. These are known as supplements. The customer is responsible for maintaining his or her copy of the contract, and any supplements. Because of the costs in providing a paper copy of an underlying contract, paper bills associated with that underlying contract only reference the underlying contract and/or supplement(s). A biller does not include a copy of an underlying contract, and supplement(s) if applicable, with each paper bill presented to a customer.

For bills presented electronically, printing costs do not exist, and distribution costs are greatly reduced in comparison to postage costs for paper bills. However, a lengthy electronic document still has a greater cost than a shorter electronic document. Longer documents require more storage space, for both the biller and the customer, than shorter documents. Longer documents also require more bandwidth to transmit to the customer than shorter documents. Storage and bandwidth both have quantifiable costs. As such, electronic billers do not transmit electronic copies of underlying contracts, or other information associated with billing data, with electronic bills. Furthermore, billers do not conventionally provide electronic versions of underlying contracts even if bills associated with those contracts and/or other information are electronically presented. As such, a customer who receives an electronically presented bill must reference both a paper document, the underlying contract or other information, and an electronic document, the bill associated with the underlying contract, to obtain a full explanation of the charges included in the electronically presented bill. The other information associated with billing data can include tariffs, titles held by billers, and other information. Accordingly, a need exists for an electronic bill presentment technique which does not require reference to paper documents for explanation of electronically presented bills.

Introduced above, to obtain a detailed explanation of charges included in a bill that references an underlying contract, a customer must turn to a separate document, the contract itself, or supplements to the contract. Oftentimes a customer has failed to retain a copy of the contract, cannot find the contract, cannot find the correct supplement to the contract, or when the contract and any supplements are available, is unable to find relevant sections of the contract or supplements to the contract. In these situations, the customer often contacts the biller's customer care department for further explanation of the charges included in the bill. These customer care sessions incur a cost to the biller. Accordingly, a need exists for an electronic bill presentment technique that reduces the number of customer care sessions.

### OBJECTS OF THE INVENTION

It is an object of the present invention to provide a technique of electronic bill presentment in which reference to paper documents is not required for explanation of electronically presented bills.

It is a further object of the present invention to provide a technique of electronic bill presentment which reduces costs associated with customer care issues.

The above-stated objects, as well as other objects, features, and advantages, of the present invention will become readily apparent from the following detailed description which is to be read in conjunction with the appended drawings.

### SUMMARY OF THE INVENTION

In accordance with the present invention, a first method and system are provided for presenting a bill and associated non-bill information. The presented bill could be a bill for any type of goods and/or services provided by a biller to a payer. The bill could be for goods and/or services provided in the past, or for goods and/or services to be provided in the future.

Preferably, the bill and associated non-bill information are presented via a network. The network could be a public network, such as the Internet, a private network, such as a local area network, or any other type of network over which information can be transmitted. A bill for a payer is transmitted via the network to the payer.

The transmitted bill includes a first charge, a second charge, a location identifier of first non-bill information upon which the first charge is based, and a location identifier of second non-bill information upon which the second charge is based. The transmitted bill could be a summary bill, or the transmitted bill could be a detailed bill. The first charge and the second charge are each a brief description of a charge typically found in a presented bill. The descriptions of charges can each be any type description of a charge typically included in a presented bill, whether paper or electronic. The presented bill could also include other information conventionally provided in a bill. The location identifiers can each be text describing a location and can each include a hyper-link, an icon, or other graphical information identifying a location. Each location identifier can be selectable to request the non-bill information. Information upon which a charge is based is information other than information that is included in presented bills. This can include, but is not limited to, an underlying contract between the biller and the payer, such as an insurance agreement, a governmental regulation under which a biller provides a service, such as a tariff, an explanation of benefits provided, or a warranty. Thus, according to this first method, the presented bill includes at least two charges and two location identifiers of non-bill information upon which the charges are based. The presented bill does not include the non-bill information.

The first non-bill information and the second non-bill information could be the same information, or could be different information. That is, the first charge and the second charge could each be based upon the same non-bill information, or the charges could be based upon different non-bill information. If based upon the same non-bill information, the first non-bill information and the second non-bill information could be different portions of the same document. Or, the first non-bill information could be based upon a part of, or the whole of, a first document, and the second non-bill information could be based upon a part of, or the whole of, a second document different than the first document.

In accordance with this first method, a request is received from the payer, via the network, for at least one of the first non-bill information and the second non-bill information. That is, after receiving the bill, the payer requests to receive at least one or both of the first and the second the non-bill information. In response to the received request from the payer for non-bill information, the requested non-bill information is transmitted to the payer. After transmission of non-bill information, the payer has been presented both the bill and non-bill information upon at least one charge is based.

According to a beneficial aspect of the present invention, the first non-bill information is a first portion of a document, and the second non-bill information is a second portion of the same document. The second portion could be a different portion than the first portion, or could be the same portion as the first portion.

In yet another beneficial aspect of the present invention, the location identifier of the first non-bill information includes a first hyper-link. Likewise, the location identifier of the second non-bill information includes a second hyper-link. One or both of the first and the second hyper-links are activated to request non-bill information. Activating the first hyper-link requests the first non-bill information, and activating the second hyper-link requests the second non-bill information.

In an especially beneficial aspect of the present invention, the bill, the including the first and the second location identifiers, is transmitted to the payer by a bill presentment server, and the non-bill information is transmitted to the payer by a non-bill presentment server. The bill presentment server and the non-bill presentment server could be located at the same location, or could be located at different locations. Both the bill presentment server and the non-bill presentment server could be associated with a biller, or could both be associated with a bill presentment service provider. In an especially preferred and beneficial aspect of the present invention, the bill presentment server is associated bill presentment service provider, while the non-bill presentment server is associated with a biller. That is, a bill presentment service provider presents the bill, including the location identifiers, while a biller presents the non-bill information.

According to yet another beneficial aspect of the present invention, the bill also includes a location identifier of non-bill information other than non-bill information upon which a charge is based. Preferably this non-bill information is associated with the bill. Though, it could be information not associated with the bill. If associated with the bill, the non-bill information could be, for example, a title of property securing a loan for which a payment is electronically billed.

The system to implement this first method of the present invention includes a first network station and a second network station. A network station could be a personal digital assistant (PDA), cellular or digital telephone, personal computer, high power workstation, server, or sophisticated mainframe computer, or any computing device capable of performing the functions described herein. Further, the first network station can be a first type computing device, while the second network station can be a second type computing device different than the first type. The first network station is configured, e.g. programmed, to transmit, via a network, a bill, as described above, to the second network station. The second network station is configured, e.g. programmed, to receive the transmitted bill, to transmit a request for non-bill information, also as described above, and to receive the requested non-bill information via the network.

According to one aspect of this system, the second network station is associated with a payer. The first network station could be associated with either a biller or a bill presentment service provider. In this aspect, the first network station is also configured to store the first and the second non-bill information and transmit the request non-bill information to the second network station. Thus, the first network station both presents the bill and presents the non-bill information.

According to another aspect of this system, the system further includes a third network station. This third network station can be any of the types of computing devices described above, or a different type. This third network station is configured, e.g. programmed, to store the first and the second non-bill information, receive the request for the non-bill information, and transmit the requested non-bill information to the second network station via the network. According to this aspect of the present invention, the first network station is associated with a bill presentment service provider, the second network station is associated with a payer, and the third network station is associated with a biller. Thus, one network station presents the bill, while a different network station presents non-bill information.

Also in accordance with the present invention, a database for storing bill information and associated non-bill information is provided. The database stores information indicating a charge. This charge is as described above. The database also stores non-bill information upon which the charge is based. The non-bill information upon which the charge is based is stored in association with the information indicating the charge.

Also in accordance with the present invention, a second method and system are provided for presenting a bill and associated non-bill information. According to this second method, a bill is transmitted to a payer via a network. The bill of this second method includes a charge and a location identifier of a portion of non-bill information upon which the charge is based. The relevant portion of the non-bill information upon which the charge is based is identified by the location identifier. The bill could also include additional charges as well as additional location identifiers. As in the first method, a request from the payer is received. This request is for the portion of non-bill information. In response to the request, the portion of non-bill information is transmitted to the payer.

Beneficially, the portion of non-bill information, according to one aspect off this second method, is a portion of one of a contract, a tariff, or a warranty. Further, in another advantageous aspect of this second method, the bill, including the location identifier, is transmitted by one of a bill presentment service provider or a biller. According to this aspect, the portion of non-bill information is transmitted by the biller.

In another advantageous aspect of the second method, the location identifier is a first location identifier. The bill includes a second location identifier of non-bill information. This non-bill information is non-bill information other than non-bill information upon which a charge is based, as discussed above. This second non-bill information could be an entire document, or a portion of a document.

The system to implement this second method of the present invention, like the first system, includes a first network station and a second network station, as described above. The first network station is configured, e.g. programmed, to transmit, via a network, a bill, as described in the second method, to the second network station. The second network station is configured, e.g. programmed, to receive the transmitted bill, to transmit a request for the portion of non-bill information, and to receive the portion of non-bill information.

According to one aspect of this second system, the first network station is associated with one of a biller or a bill presentment service provider, and the second network station is associated with a payer. The first network station is also configured to store the non-bill information, receive the request for the portion of the non-bill information, and transmit the portion of the non-bill information to the second network station. Thus, a single network station presents both the bill and the portion of the non-bill information. Furthermore, the first network station stores the entire non-bill information, while it only transmits the request portion of the non-bill information.

According to another aspect of this system, a third network station is provided. This third network station is configured to store the non-bill information, receive the request for the portion of the non-bill information, and transmit the requested portion of the non-bill information to the second network station. In this aspect, the third network station is associated with a biller, the first network station is associated with a bill presentment service provider, and the second network station is associated with a payer.

It will be understood by one skilled in the art that the methods of the present invention is easily implemented using computer software. More particularly, software can be easily programmed, using routine programming skill, based upon the description of the invention set forth herein and stored on a storage medium which is readable by a computer processor to cause the computer to operate such that the method of the present invention is performed as described herein.

### BRIEF DESCRIPTION OF THE DRAWINGS

In order to facilitate a fuller understanding of the present invention, reference is now made to the appended drawings. These drawings should not be construed as limiting the present invention, but are intended to be exemplary only.

FIG. 1 is a simplified depiction of a prior art electronically presented bill.

FIG. 2 is a simplified depiction of an electronic bill presentment system in accordance with the present invention.

FIG. 3 is a simplified schematic diagram of a data processing system.

FIG. 4A is a first alternative depiction of an electronically presented bill in accordance with the present invention.

FIG. 4B is a second alternative depiction of an electronically presented bill in accordance with the present invention.

FIG. 5 is a first alternative flow chart diagram for a biller-direct model of bill and non-bill information presentation according to the present invention.

FIG. 6 is a simplified depiction of electronically presented non-bill information in accordance with the present invention.

FIG. 7 is a second alternative flow chart diagram for a biller-direct model of bill and non-bill information presentation in accordance with the present invention.

FIG. 8 is a first alternative flow chart diagram for an aggregation model of bill and non-bill information presentation in accordance with the present invention.

FIG. 9 is a second alternative flow chart diagram for an aggregation model of bill and non-bill information presentation accordance with the present invention.

### DETAILED DESCRIPTION OF PREFERRED EMBODIMENTS

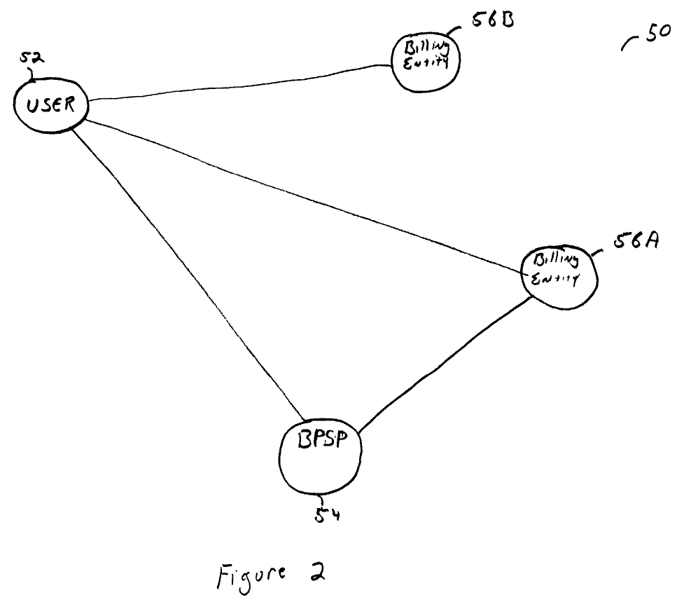

Referring to FIG. 2 there is shown a schematic diagram of an electronic bill presentment system 50 in accordance with the present invention. The system 50 comprises a user entity 52, a bill presentment service provider (BPSP) 54, a first billing entity 56A, and a second billing entity 56B. For purposes of this detailed description, the bill presentment service provider 54 is not depicted as an electronic payment service provider. However, it should be understood that that electronic bill payment could be a readily included feature of the bill presentment service provider 54.

At this point it should be noted that although only a single user entity 52 and two billing entities 56A and 56B are shown in the system 50, it is common to have a multitude of such entities in an actual electronic bill presentment network in accordance with the present invention.

Billing entity 56A and the user entity 52 are each in communication with the BPSP 54, as well as with one another. Billing entity 56B and the user entity 52 are also in communication with one another. It will be understood by one skilled in the art that the communication links between various ones of the user entity 52, BPSP 54, billing entity 56A, and billing entity 56B could be any type communication link. Preferably, the communications described herein travel via the Internet, though any network or networks capable of hosting these communications are adequate for the invention described herein.

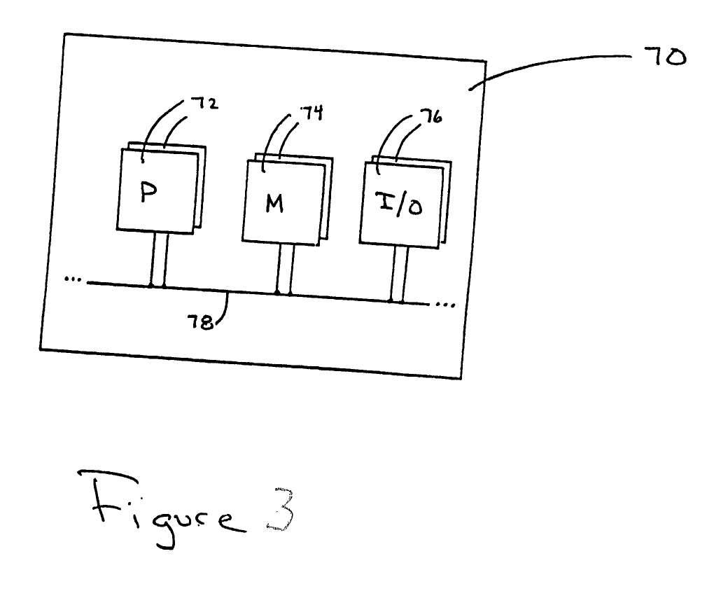

The user entity 52 preferably communicates via a personal computer (PC) that is directly connected to the system 50, or is connected to the system 50 through a network server. However, any computing device capable of performing as described herein, as will be understood by one skilled in the art, can be utilized in place of a personal computer. The BPSP 54 and each of the billing entities 56A and 56B can each generally be described in terms of data processing systems, such as shown in FIG. 3. Each data processing system 70 preferably comprises at least one processor (P) 72, memory (M) 74, and input/output (I/O) interface 76, which are connected to each other by a bus 78, for implementing the functions as described in detail below. The BPSP 54 and each of the billing entities 56A and 56B gains access to the system 50 through one or more network servers, which often are part of a data processing system 70.

The memory 72 associated with the BPSP 54, the memory 72 associated with the first billing entity 56A, and the memory 72 associated with the second billing entity 56B each include a database component. The database component associated with BPSP 54 stores bill information received from billing entity 56A. Each database component associated with billing entities 56A and 56B includes at least two sections, a section for storing non-bill information, and a section for storing bill information. It will be recognized that the database component associated with BPSP 54 can also store non-bill information received from billing entity 56A. If so, the database associated with BPSP 54 also includes at least two sections. Bill information includes any information traditionally included with bills presented to customers, as described above. Non-bill information includes information other than traditional bill information, such as electronic versions of underlying contracts associated with bills presented to customers, also as described above. In addition, non-bill information can also be other types of information associated with a bill, as will be described further below.

It should be understood that a database component associated with any one or all of the BPSP 54, the first billing entity 56A, and the second billing entity 56B could be located in a memory other than memory 72. For example, the database component associated with the second billing entity 56B could be located in a legacy storage, accounting, billing, or other system.

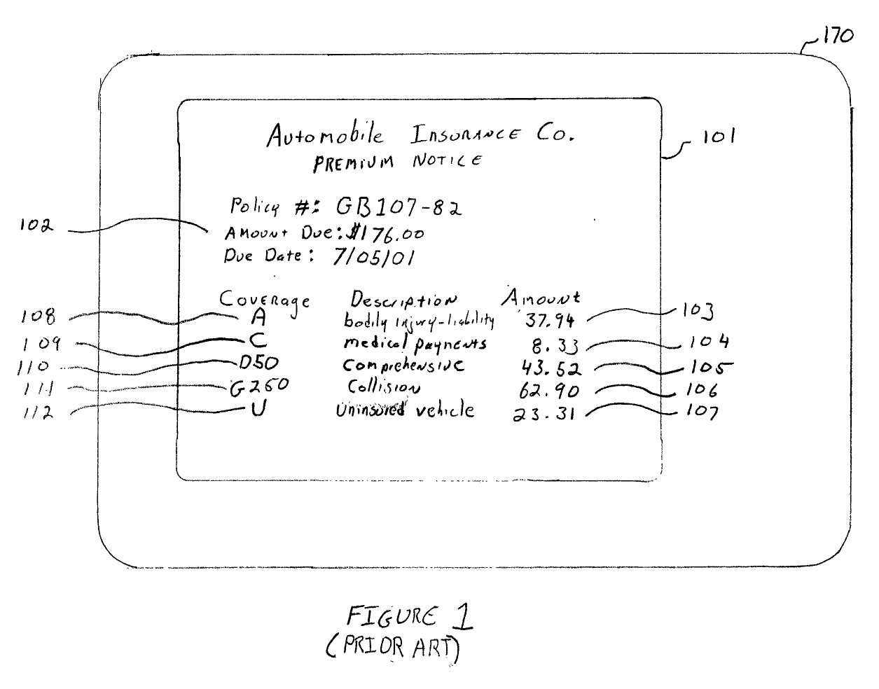

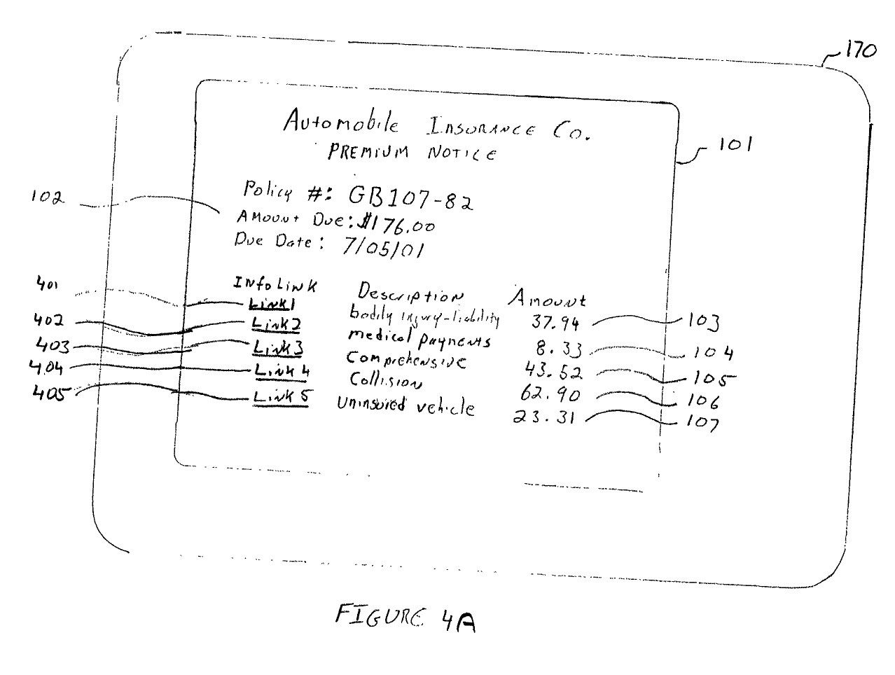

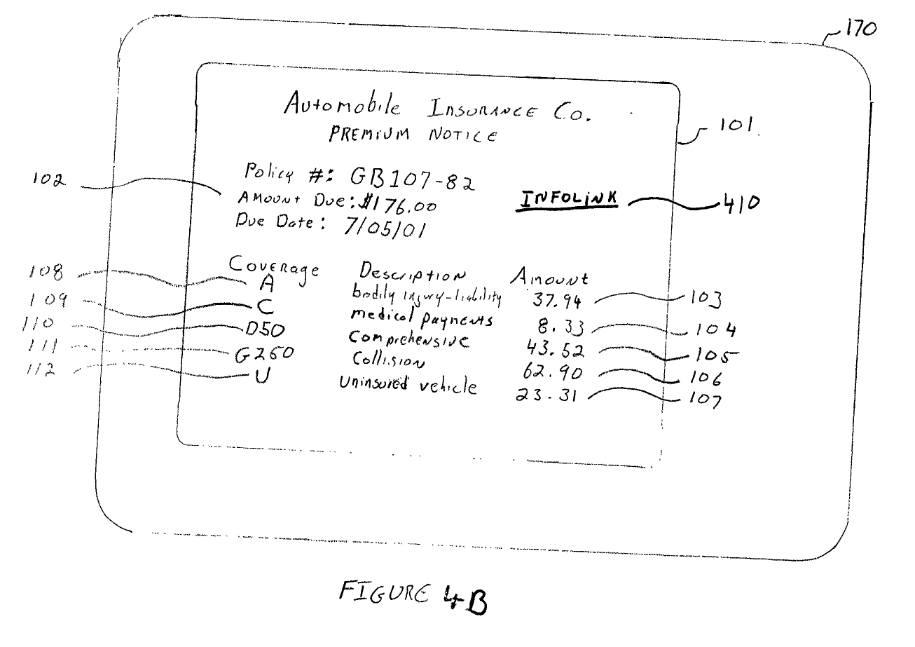

FIG. 4A is a simplified first alternative depiction of an electronically presented bill in accordance with the present invention. As shown, the electronic bill of FIG. 4A includes the same visual information as the prior art electronic bill of FIG. 1. However, this electronic bill includes links 401-405 that are each associated with preferably a portion of non-bill information stored in a database component. Selecting one of these links causes targeted non-bill information to be transmitted to the customer's computer. Each one of links 401-405 can be termed a targeted link. In this example, the non-bill information is an insurance contract. Selecting one of targeted links 401-405 causes a portion of the insurance contract to be transmitted to the customer's computer. Of course, one or more of targeted links 401-405 could link to a portion of non-bill information contained in a different document to which one or more of the other links link. Further, an electronically presented bill could, in accordance with the present invention, contain only one targeted link. Additionally, one or more of targeted links 401-405 could be associated with an entire non-bill information document. These is especially beneficial when an entire document is relevant.

FIG. 4B is a simplified second alternative depiction of an electronically presented bill in accordance with the present invention. As shown in FIG. 4B, the depicted electronic bill also includes the same visual information as the prior art electronic bill of FIG. 1. Shown also is link 410. Link 410 is associated with non-bill information stored in a database component. However, link 410 is not associated with an individual charge included in the bill. Selecting this link, which can be termed a general link, causes an entire non-bill information document to be transmitted to the customer's computer. This non-bill information which is associated with general link 410 could be the entire non-bill information of which targeted links 401-405 of FIG. 4A are each associated with a portion, or could be different non-bill information. Though not shown, the electronic bill of FIG. 4B could include multiple general links, each to whole and different non-bill information.

Of course, an electronically presented bill, in accordance with the present invention, could include the targeted links depicted in FIG. 4A, as well as the general link depicted in FIG. 4B, though this is not shown. Further, multiple general links as well as targeted links could be presented in the same electronic bill. When a single general link and multiple targeted links are presented together, at least three alternatives are possible. In a first alternative, each of the targeted links 401-405 are associated with a portion of one or more non-bill information documents, also known as items, and general link 410 is associated with the entire non-bill information document. Thus, activating a targeted link 401-405 would return a portion of non-bill information, and activating the general link 410 would return the whole non-bill information of which the targeted non-bill information is a portion. In a second alternative, each of the targeted links 401-405 are associated with a portion of a first non-bill information document, and general link 410 is associated with an entire second non-bill information document. Thus, activating a targeted link 401-405 would return a portion of the first non-bill information, and activating the general link 410 would return the whole second non-bill information. And also, in yet another alternative, one or more of targeted links 401-405 could be associated with a portion of a different non-bill information document than the remaining targeted links 401-405, and the general link 410 could be associated with yet a different non-bill information document. It will be recognized that other alternatives are possible, and are fully within the scope of the present invention.

### FIRST EMBODIMENT

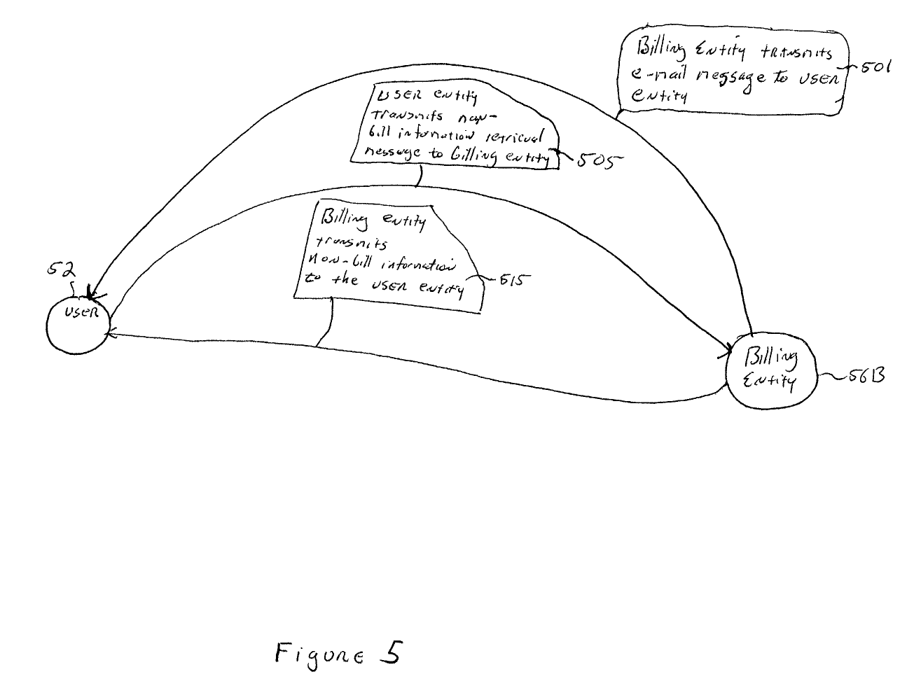

FIG. 5 depicts a first alternative exemplary flow of communications between the user entity 52 and the second billing entity 56B in biller-direct electronic bill and non-bill information presentation. In this embodiment, an electronic bill is presented to user entity 52 via e-mail. At step 501 the second billing entity 56B transmits an e-mail message to the user entity 52. This e-mail message is an electronic bill. This electronic bill could be as shown in FIG. 4A or in FIG. 4B. Further, the electronic bill could have an alternative configuration, such as those discussed above. At step 505, after the user entity 52 selects a link, for example link 401, a non-bill information retrieval message is transmitted to the second billing entity 56B. This message could be an email message, or could be a message sent via the World Wide Web, or via another messaging protocol. Upon receipt of this message, the second billing entity 56B retrieves the appropriate non-bill information from the database component associated with that billing entity and transmits this retrieved information to the user entity 52, step 515. This could be a second e-mail message from the billing entity 56B to the user entity 52. Or, it could be a message sent via the World Wide Web or other messaging protocol. Upon receipt of this message, the second billing entity 56B retrieves the appropriate non-bill information from the database component associated with that billing entity and transmits this retrieved information to the user entity 52, step 515. This could be a second e-mail message from the billing entity 56B to the user entity 52. Or, it could be a message sent via the World Wide Web or other messaging protocol.

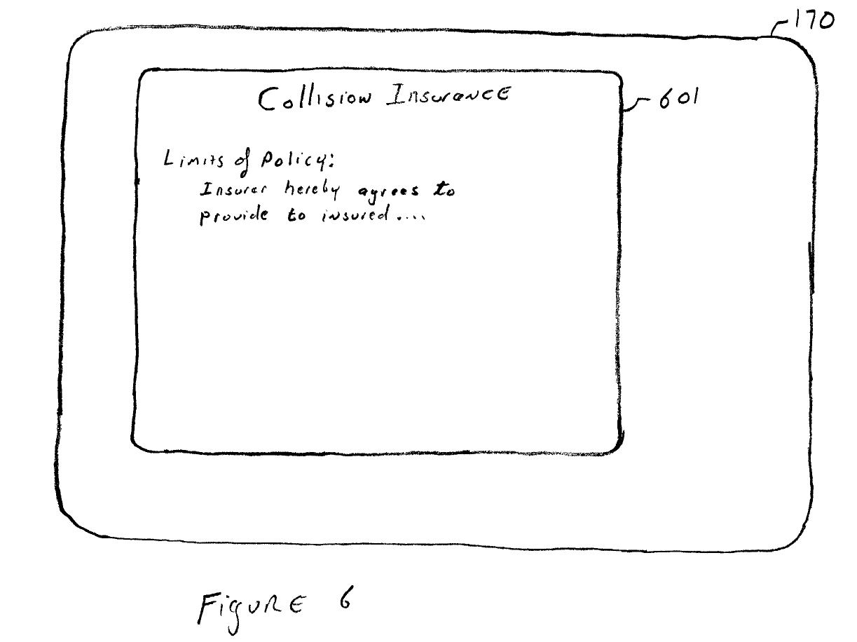

A link to non-bill information that is included in an electronic preferably has index parameters associated with it. These index parameters are used by the entity transmitting the non-bill information to retrieve the appropriate non-bill information from a database component. Other type parameters can also be associated with a link. These include user information to support user authentication for control of access to non-bill information. The use of index parameters, known as indexing, will be understood by one skilled in the art. For targeted links, non-bill information, in this example, an automobile insurance contract, stored in a database component is sectioned such that each sectioned portion of the non-bill information corresponds to at least one targeted link, such as those shown in the electronic bill of FIG. 4A. Index parameters associated with a targeted link within an electronic bill directs retrieval of the appropriate sectioned portion of non-bill information. FIG. 6 is a simplified depiction of targeted non-bill information associated with link 404 as electronically presented 601. As shown, this link references information related to collision insurance. It will be appreciated that any given section of non-bill information may be relevant to multiple portions of an electronically presented bill. The user entity 52 can access each referenced portion of non-bill information as often as necessary. Thus, by selecting an appropriate targeted link, the relevant portion of the non-bill information is electronically presented to a customer. It will be understood that if an electronic bill includes only a single general link to an entire non-bill information document, selection of that link will direct retrieval of the entire non-bill information document. Of course, a single electronically presented bill could include links to both targeted non-bill information and an entire non-bill information document. That is, one or more links would include index parameters, while one or more other links would not include index parameters.

### SECOND EMBODIMENT

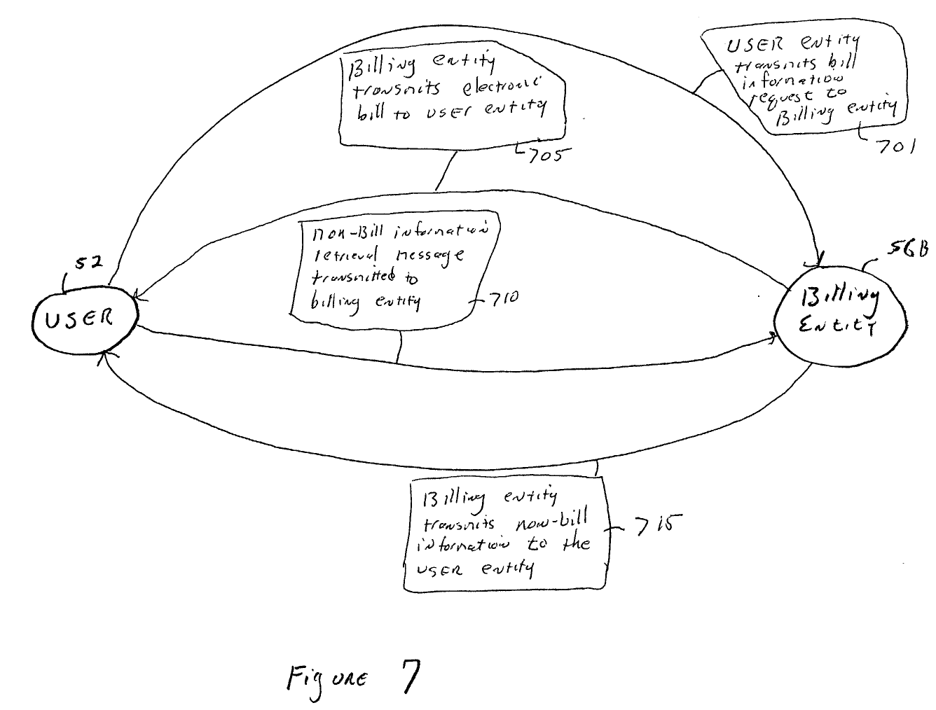

FIG. 7 depicts a second alternative exemplary flow of communications between the user entity 52 and the second billing entity 56B in a biller-direct electronic bill and non-bill information presentation. In this embodiment, the electronic bill and non-bill information are each presented to user entity 52 via the World Wide Web. However, another messaging protocol other than an e-mail protocol could be utilized. At step 701 the user entity 52 transmits a request for bill information to the second billing entity 56B. Upon receipt of this request, the second billing entity 56B retrieves a bill. Of course, as will be understood, a bill might not be stored in a formatted state, for example as shown in FIG. 4A or FIG. 4B. That is, the information included in the bill could be stored in a non-formatted state, the information would then be processed to appear in the form of a bill only upon a request from a user entity for bill information. At step 705 the second billing entity 56B transmits the electronic bill to the user entity 52. As described in the first embodiment, selecting a link causes a non-bill information retrieval message to be transmitted to the second billing entity 56B, step 710. Upon receipt of this message, the second billing entity 56B retrieves the appropriate non-bill information from the database component associated with that billing entity and transmits this retrieved information to the user entity 52, step 715. This could be a targeted portion of non-bill information, or a complete non-bill information document.

It should be appreciated and be apparent from the Figures and description above that in the first and the second embodiments, the BPSP 54 is not required to participate in electronically presenting bill and non-bill information to a customer of a biller. That is, according to these first two embodiments of the present invention, the BPSP 54 is not necessary, as these are biller-direct embodiments. However, as described below, the BPSP 54 is required in the additional embodiments disclosed herein.

### THIRD EMBODIMENT

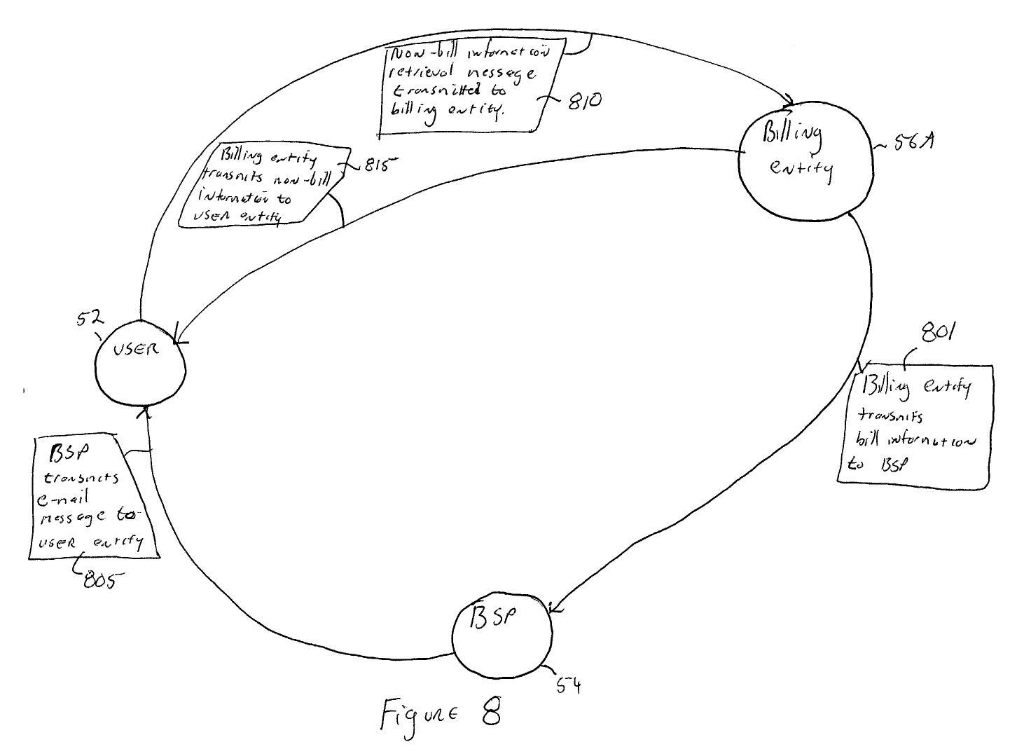

FIG. 8 depicts a first alternative exemplary flow of communications between the user entity 52, the BPSP 54, and the first billing entity 56A in electronic bill and non-bill information presentation in an aggregation model. As in the first embodiment, here the electronic bill is presented via e-mail.

At step 801 the first billing entity 56A transmits bill information to the BPSP 54. This may be formatted detailed bill information, similar to that shown either in FIG. 4A or 4B, or it may be unformatted detailed information. Furthermore, as will be understood by one skilled in the art, this could also be summary bill information instead of detailed bill information. If the transmitted bill information is summary bill information, the summary bill information contains at least one link to detailed bill information. In addition, summary information could contain one or more links to non-bill information. Additionally, summary information could be transmitted either formatted or unformatted. If the transmitted information is detailed bill information, formatted or unformatted, the links are also transmitted to the BPSP 54 by the first billing entity 56A. And, if the transmitted information is summary bill information, formatted or unformatted, at least one link to detailed bill information is also transmitted. One or more links to non-bill information could also be transmitted. As will be understood, the non-bill information is stored in a database component at the first billing entity 56A.

After receiving bill information from the first billing entity 56A, and formatting the received information if necessary, BPSP 54 transmits an e-mail message to user entity 52, step 805. This could be a formatted detailed bill, or could be a formatted summary bill. If the e-mail message is a detailed bill, the message includes at least one link to non-bill information stored in the database component associated with the first billing entity 56A. Selecting a link in this detailed bill causes a non-bill information retrieval message to be transmitted from the user entity 52 to the first billing entity 56A, step 810. Upon receipt of this message, the first billing entity 56A retrieves the appropriate non-bill information from its database component and transmits this retrieved information to the user entity 52, step 815, as will be understood from the discussion above. The non-bill information retrieval message, as well as the non-bill information itself, do not flow through the BPSP 54 in this embodiment. This is especially beneficial, as this information is often private and/or sensitive.

If the e-mail message is a summary bill, the summary contains at least a link to detailed bill information. Selecting the link to detailed bill information causes a detailed bill retrieval request to be transmitted to the first billing entity 56A. Upon receipt of this request, the first billing entity transmits a formatted detailed bill to the user entity 52. If a link to non-bill information is chosen from this detailed bill information, operations continue as described in steps 810 and 815.

### FOURTH EMBODIMENT

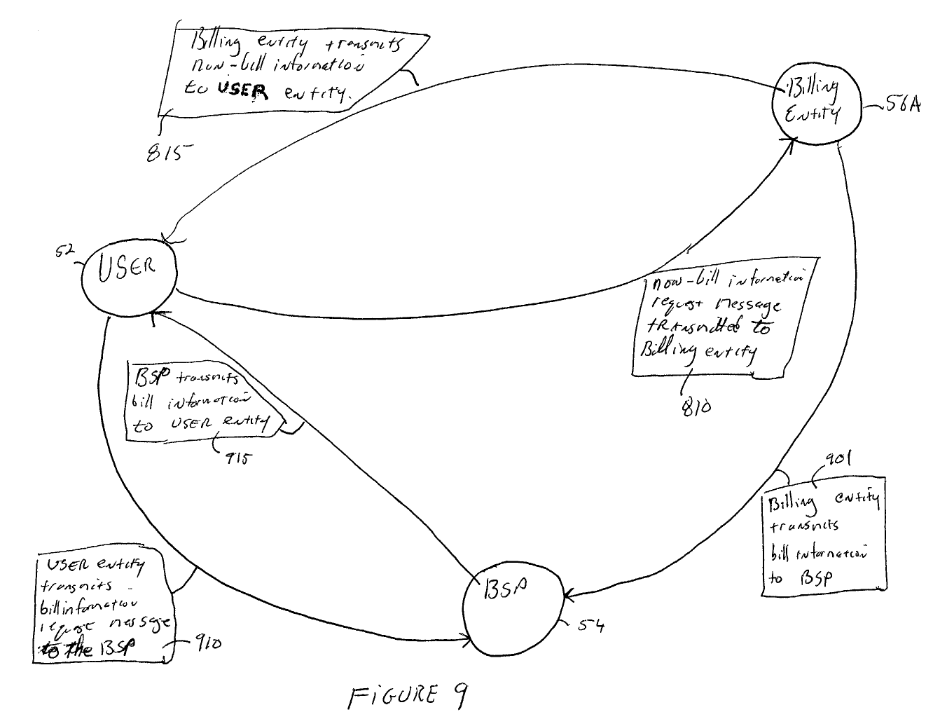

FIG. 9 depicts a second alternative exemplary flow of communications between the user entity 52, the BPSP 54, and the first billing entity 56A in electronic bill and non-bill information presentation in an aggregation model. As in the second embodiment, here the electronic bill is presented via the World Wide Web or other messaging protocol other than e-mail.

At step 901 the first billing entity 56A transmits the same bill information to the BPSP 54 as described in step 801 above. After receiving bill information from the first billing entity 56A the BPSP 54 stores the received bill information in the database component associated with the BPSP 54. As discussed above, the received information may be stored in a formatted state, or stored in an unformatted state and formatted when requested by the user entity 52. And, as above, this may be either detailed or summary information. User entity 52 transmits a request for bill information to the BPSP 54, step 910. Upon receipt of this request, the BPSP 54 transmits the bill information to the user entity 52, step 915. As in the third embodiment, this could be summary bill information or detailed bill information.

If detailed bill information is transmitted to the user entity 52, operations continue as described above and depicted in steps 810 and 815. If summary bill information is transmitted to the user entity 52, operations continue as described above in the third embodiment relating to summary bill information. If the summary bill information contains one or more links to non-bill information, operations to access non-bill information from summary bill information are as described above and shown in steps 810 and 815. To obtain detailed bill information, the user entity 52 transmits a request for detailed bill information to the first billing entity 56A. The first billing entity 56A then transmits detailed bill information to the user entity 52. Operations after selection of a non-bill information link are as described above.

In each of the above-described embodiments, non-bill information is stored in only one place, in a database component associated with a billing entity. When an electronic bill includes links to targeted portions of non-be bills, invoices, and statements generated by health insurance companies, hospitals, or medical practices.

Further applications of the present invention will be readily apparent to those skilled in the art. For example, insurance premiums often include a brief description of a provision of an insurance contract under which a service was provided on behalf of an insured customer in the past billing cycle. That is, in addition to billing for future services, insurers can bill for services provided in the past. An electronic bill could be linked to the relevant portion of the insurance contract under which these services were provided. In particular, many insurance contracts include deductible or co-payment provisions. When these are billed for by an insurance company, a link to the relevant portion of the insurance contract describing customer responsibility for such changes can be provided in an electronic bill. Also, many warranties also include deductibles or co-payments. Electronically presented bills could thus link to relevant portions of a warranty to fully explain the bill. In another application of the present invention, non-bill information could be a document or item such as a title held by a lender. For example, a lender could hold the title to an automobile which secures a loan. An electronically presented bill on the loan could include a general link to the title, as well as targeted links or other general links. In this manner, the borrower could link to and view the title when a bill is presented.

The present invention is not to be limited in scope by the specific embodiments described herein. Indeed, various modifications of the present invention in addition to those described herein, will be apparent to those of skill in the art from the foregoing description and accompanying drawings. Thus, such modifications are intended to fall within the scope of the appended claims.

What is claimed is:

1. A method for presenting a bill and associated non-bill information via a network, comprising;
transmitting to a payer, via a network, a bill including a first charge, a second charge, a location identifier of first non-bill information upon which the first charge is based, and a location identifier of second non-bill information upon which the second charge is based;
receiving from the payer, via the network, a request for at least one of the first non-bill information and the second non-bill information; and
transmitting to the payer, via the network, the requested non-bill information in response to the received request.

2. The method of claim 1, wherein:
the first non-bill information is a first portion of a document; and
the second non-bill information is a second portion of the same document.

3. The method of claim 2, wherein the document is one of a contract, a tariff, or a warranty.

4. The method of claim 1, wherein the location identifier of the first non-bill information includes a first hyper-link and the location identifier of the second non-bill information includes a second hyper-link, and further comprising:
activating at least one of the first hyper-link and the second hyper-link to request non-bill information.

5. The method of claim 1, wherein:
the bill, including the location identifier of the first non-bill information and the location identifier of the second non-bill information, is transmitted to the payer by a bill presentment server; and
the non-bill information is transmitted to the payer by a non-bill presentment server.

6. The method of claim 5, wherein:
the bill presentment server is associated with a bill presentment service provider; and
the non-bill presentment server is associated with a biller.

7. The method of claim 1, wherein the bill is one of a detailed bill or a summary bill.

8. The method of claim 1, wherein the bill further includes a location identifier of non-bill information other than non-bill information upon which a charge is based.

9. A system for presenting a bill and associated non-bill information, comprising:
a first network station configured to transmit, via a network, a bill including a first charge, a second charge, a location identifier of first non-bill information upon which the first charge is based, and a location identifier of second non-bill information upon which the second charge is based; and
a second network station configured to receive the transmitted bill, to transmit a request for at least one of the first non-bill information and the second non-bill information via the network, and to receive the requested non-bill information via the network.

10. The system of claim 9, wherein:
the first non-bill information is a first portion of a document; and
the second non-bill information is a second portion of the same document.

11. The system of claim 9, wherein the bill is one of a summary bill or a detailed bill.

12. The system of claim 9, wherein the document is one of a contract, a tariff, or a warranty.

13. The system of claim 9, wherein:
the location identifier of the first non-bill information includes a first hyper-link;
the location identifier of the second non-bill information includes a second hyper-link; and
the second network station is further configured to activate the first hyper-link to request the first non-bill information and to activate the second hyper-link to request the second non-bill information.

14. The system of claim 9, wherein:
the first network station is further configured to store the first non-bill information and the second non-bill information, receive the request for non-bill information, and transmit the requested non-bill information to the second network station via the network;
the first network station is associated with one of a biller or a bill presentment service provider; and
the second network station is associated with a payer:

15. The system of claim 9, further comprising:
a third network station configured to store the first non-bill information and the second non-bill information, receive the request for non-bill information, and transmit non-bill information to the second network station via the network;
wherein the first network station is associated with a bill presentment service provider, the second network station is associated with a payer, and the third network station is associated with a biller.

16. The system of claim 9, wherein the bill further includes a location identifier of non-bill information other than non-bill information upon which a charge is based.

17. A database for storing bill information and associated non-bill information, comprising:
information indicating a charge; and
non-bill information upon which the charge is based stored in association with the information indicating the charge.

18. A method for presenting a bill and associated non-bill information via a network, comprising:
transmitting to a payer, via a network, a bill including a charge and a location identifier of a portion of non-bill information upon which the charge is based;
receiving from the payer, via the network, a request for the portion of non-bill information; and
transmitting to the payer, via the network, the portion of non-bill information in response to the received request.

19. The method of claim 18, wherein the bill is one of a detailed bill or a summary bill.

20. The method of claim 18, wherein the non-bill information is one of a contract, a tariff, or a warranty.

21. The method of claim 18, wherein:
the bill including the location identifier is transmitted by one of a bill presentment service provider or a biller; and
the portion of non-bill information is transmitted by the biller.

22. The method of claim 18, wherein:
the location identifier is a first location identifier; and
the bill further includes a second location identifier of non-bill information other than non-bill information upon which a charge is based.

23. A system for presenting a bill and associated non-bill information via a network comprising:
a first network station configured to transmit, via a network, a bill including a charge and a location identifier of a portion of non-bill information upon which the charge is based; and
a second network station configured to receive the transmitted bill, to transmit a request for the portion of non-bill information, and to receive the requested portion of non-bill information via the network.

24. The system of claim 23, wherein the bill is one of a summary bill or a detailed bill.

25. The system of claim 23, wherein the non-bill information is one of a contract, a tariff, or a warranty.

26. The system of claim 23, wherein:
the first network station is further configured to store the non-bill information, receive the request for the portion of non-bill information, and transmit the requested portion of non-bill information to the second network station via the network;
the first network station is associated with one of a biller or a bill presentment service provider; and
the second network station is associated with a payer.

27. The system of claim 23, further comprising:
third network station configured to store the non-bill information, receive the request for the portion of non-bill information, and transmit the requested portion of non-bill information to the second network station via the network;
wherein the first network station is associated with a bill presentment service provider, the second network station is associated with a payer, and the third network station is associated with a biller.

28. The system of claim 23, wherein:
the location identifier is a first location identifier; and
the bill further includes a second location identifier of non-bill information other than non-bill information upon which a charge is based.

29. An article of manufacture for presenting a bill and associated non-bill information via a network, comprising:
a computer readable medium; and
computer programming stored on the medium;
wherein the stored computer programming is configured to be readable from the computer readable medium by a computer to thereby cause the computer to operate so as to:
transmit, via a network, a bill including a first charge, a second charge, a location identifier of first non-bill information upon which the first charge is based, and a location identifier of second non-bill information upon which the second charge is based;
receive, via the network, a request for at least one of the first non-bill information and the second non-bill information; and
transmit, via the network, the requested non-bill information.

30. An article of manufacture for presenting a bill and associated non-bill information via a network, comprising:
a computer readable medium; and
computer programming stored on the medium;
wherein the stored computer programming is configured to be readable from the computer readable medium by a computer to thereby cause the computer to operate so as to:
transmit, via a network, a bill including a charge and a location identifier of a portion of non-bill information upon which the charge is based;
receive, via the network, a request for the portion of non-bill information; and
transmit, via the network, the portion of non-bill information.
